(19) United States
(12) Patent Application Publication
(10) Pub. No.: US 2020/0398824 A1
(43) Pub. Date: Dec. 24, 2020

(54) PARKING ASSIST SYSTEM

(71) Applicant: HONDA MOTOR CO., LTD., Tokyo (JP)

(72) Inventors: Miki TSUJINO, Saitama (JP); Hiroshi YAMANAKA, Saitama (JP); Yuki HARA, Saitama (JP); Yasushi SHODA, Saitama (JP)

(21) Appl. No.: 16/906,673

(22) Filed: Jun. 19, 2020

(30) Foreign Application Priority Data
Jun. 24, 2019 (JP) 2019-116684
Dec. 13, 2019 (JP) 2019-225929
Mar. 26, 2020 (JP) 2020-056731

(51) Int. Cl. B60W 30/06; B60W 50/14; B60W 10/10; B60W 10/18; B60W 30/18; B60W 60/00

(52) U.S. Cl. CPC B60W 30/06; B60W 50/14; B60W 10/10; B60W 10/18; B60W 2050/146; B60W 60/0025; B60W 2540/12; B60W 2530/00; B60W 30/18009

(57) ABSTRACT

A parking assist system includes: a control device configured to control an autonomous parking operation to move a vehicle autonomously to a prescribed target parking position; a brake input member configured to receive a brake operation of the vehicle by an occupant, and a vehicle state detecting device configured to detect a state of the vehicle, wherein during control of the parking operation, when the control device determines that the state of the vehicle detected by the vehicle state detecting device is a prohibition state in which the parking operation should be prohibited, the control device suspends the parking operation so as to stop a movement of the vehicle and does not resume the parking operation unless the brake operation is detected.

### TECHNICAL FIELD

The present invention relates to a parking assist system configured to move a vehicle autonomously and park the vehicle.

### BACKGROUND ART

A known parking assist device executes parking assistance that guides a vehicle to a target parking position (for example, JP2015-74264A and JP2015-74265A). This parking assist device executes the parking assistance by executing automatic steering. This kind of parking assist device includes a touch panel as a display device, and suspends the parking assistance when a suspension button displayed on the touch panel is operated.

A known travel assist device executes parking assistance by displaying a screen for assisting a parking operation on a touch panel mounted on a vehicle (for example, JP2019-23008A). In this travel assist device, when the vehicle is parked at a target parking position and thereby the parking assistance ends, the touch panel displays an assistance end notification screen. Thereafter, the touch panel displays a look-down view screen that enables an occupant to check the surroundings. In a case where the parking assistance ends in a state where the vehicle has not been parked at the target parking position and the assistance end notification screen has not been switched to the look-down view screen, the travel assist device operates an automatic brake until the assistance end notification screen is switched to the look-down view screen.

In a parking assist system that executes the so-called automatic parking to move a vehicle autonomously and park the vehicle, it is desirable that an occupant such as a driver can resume parking assistance in a case where the parking assistance is suspended. On the other hand, in order to ensure safety when the vehicle starts moving, it is desirable that resumption of the automatic parking is prohibited when the occupant is not in a posture to appropriately perform a braking operation of the vehicle.

### SUMMARY OF THE INVENTION

In view of such a problem of the prior art, a primary object of the present invention is to provide a parking assist system that executes automatic parking and can ensure safety of a vehicle when an occupant is not in a posture to perform a braking operation of the vehicle.

To achieve such an object, one embodiment of the present invention provides a parking assist system (1, 51, 101), including: a control device (15) configured to control an autonomous parking operation to move a vehicle autonomously to a prescribed target parking position; a brake input member (24) configured to receive an input of a brake operation of the vehicle by an occupant, and a vehicle state detecting device (12, 13) configured to detect a state of the vehicle, wherein during control of the parking operation, when the control device determines that the state of the vehicle detected by the vehicle state detecting device is a prohibition state in which the parking operation should be prohibited, the control device stops a movement of the vehicle and does not allow the parking operation to resume unless the input to the brake input member is detected.

According to this arrangement, when the parking operation of the vehicle should be prohibited, the vehicle is stopped. Thereafter, when the occupant performs the input to the brake input member, the parking operation is allowed to resume. Accordingly, the parking operation is allowed to resume only in a case where the occupant is in a posture to perform a braking operation of the vehicle (namely, to perform the input to the brake input member). Therefore, when the occupant is not in a posture to perform the braking operation of the vehicle, it is possible to prohibit the resumption of the parking operation, and thereby to ensure the safety when the parking operation is resumed.

Preferably, the control device resumes the movement of the vehicle when the input to the brake input member is released after the input to the brake input member is detected.

According to this arrangement, the movement of the vehicle is resumed when the input to the brake input member is released. Accordingly, the occupant can easily understand the timing when the movement of the vehicle is resumed.

Preferably, the parking assist system further includes an input/output device (14) configured to receive an input by the occupant and to execute a prescribed notification to the occupant based on an instruction from the control device, wherein when the control device determines that the state of the vehicle is the prohibition state, the control device stops the movement of the vehicle, makes the input/output device execute a notification to urge the input to the brake input member, and makes the input/output device receive an input as to whether to resume the parking operation, and when the input to the brake input member is detected and the input/output device receives an input for resuming the parking operation, the control device resumes the parking operation.

According to this arrangement, when two inputs (namely, the input to the brake input member and the input for resuming the parking operation) are performed after the state of the vehicle becomes the prohibition state and the vehicle is stopped, the parking operation is resumed. Accordingly, it is possible to prevent the parking operation from being resumed due to an erroneous operation by the occupant, and thereby to ensure safety when the parking operation is resumed. In addition, since the notification to urge the input to the brake input member is executed, the occupant can easily understand that the input to the brake input member is necessary for resuming the parking operation.

Preferably, when an abnormality of the vehicle including the input/output device is detected, the control device stops the movement of the vehicle and makes the input/output device execute a notification to urge the input to the brake input member.

According to this arrangement, in a case where the abnormality of the vehicle is detected, the notification to urge the input to the brake input member is executed, as in a case where the state of the vehicle becomes the prohibition state. Therefore, it is possible to execute consistent notifications to the occupant.

Preferably, the parking assist system further includes a shift actuator (17) configured to change a shift position based on a signal from the control device, wherein when the abnormality of the vehicle including the input/output device is detected, the control device stops the movement of the vehicle, and when the input to the brake input member is detected, the control device drives the shift actuator so as to change the shift position to a parking position.

According to this arrangement, in a case where the abnormality of the vehicle is detected, unlike a case where the state of the vehicle becomes the prohibition state, the parking operation is not resumed. Therefore, it is possible to enhance safety of the vehicle.

Preferably, the vehicle state detecting device includes a driving operation sensor (12) configured to detect an input of a driving operation by the occupant, and the control device determines that the state of the vehicle is the prohibition state in a case where the driving operation sensor detects the input of the driving operation.

According to this arrangement, by using the driving operation sensor, it is possible to detect the input of the driving operation for overriding an autonomous movement of the vehicle. Namely, by using the driving operation sensor, it is possible to detect that the state of the vehicle becomes the prohibition state in which the parking operation should be prohibited.

Preferably, the vehicle state detecting device includes at least one of a door open/close sensor (29) configured to detect opening and/or closing of a door of the vehicle, a seat belt sensor (30) configured to detect a fastening state of a seat belt, and a door mirror position sensor (31) configured to detect a position of a door mirror, and the control device is configured to determine whether the state of the vehicle is the prohibition state based on a detection result of the at least one of the door open/close sensor, the seat belt sensor, and the door mirror position sensor.

According to this arrangement, by using the above sensors, it is possible to detect an operation for alighting from the vehicle, an operation for extending/retracting the door mirror, and the like. Namely, by using the above sensors, it is possible to detect that the state of the vehicle becomes the prohibition state in which the parking operation should be prohibited.

Preferably, the parking assist system further includes a surrounding information acquisition device (19) configured to acquire surrounding information of the vehicle; and an input/output device (14) configured to receive an input by the occupant, to execute a prescribed notification to the occupant, and to display the surrounding information acquired by the surrounding information acquisition device, wherein when the control device determines that the state of the vehicle is the prohibition state, the control device makes the input/output device display the surrounding information in a prescribed display area (32c) and display a prescribed notification to the occupant outside the display area until the vehicle is stopped.

According to this arrangement, the surrounding information of the vehicle is displayed in the display area and the notification to the occupant is displayed outside the display area until the vehicle is stopped. Accordingly, it is possible to prevent the surrounding information from becoming indistinct due to the notification to the occupant.

Preferably, when the control device determines that the state of the vehicle is the prohibition state, the control device decelerates the vehicle so as to stop the vehicle, and after the vehicle is stopped, when the input to the brake input member is detected, the control device makes the input/output device receive an input for resuming the parking operation.

According to this arrangement, after the vehicle is stopped, the input for resuming the parking operation is received on condition that the input to the brake input member is performed. Accordingly, it is possible to receive the input for resuming the parking operation after confirming that the occupant is in a posture to execute the input to the brake input member, and thereby to enhance safety of the vehicle.

Preferably, when the control device determines that the state of the vehicle is the prohibition state, the control device decelerates the vehicle so as to stop the vehicle, and after the vehicle is stopped, when the input to the brake input member is detected, the control device makes the input/output device receive the input for resuming the parking operation regardless of whether the state of the vehicle is the prohibition state.

According to this arrangement, after the vehicle is stopped, the input for resuming the parking operation is received regardless of the state of the vehicle on condition that the input to the brake input member is performed. Therefore, the occupant can easily input an intention to resume the parking operation without worrying about the state of the vehicle, so that the convenience of the vehicle is enhanced.

Preferably, when one or more prohibition conditions are satisfied, the control device determines that the state of the vehicle is the prohibition state and stops the vehicle, after the vehicle is stopped, when the input to the brake input member is detected and the input/output device receives an input for resuming the parking operation in a state where the prohibition conditions are satisfied, the control device makes the display area of the input/output device sequentially display notifications respectively related to the prohibition conditions being satisfied, and the control device allows the parking operation to resume when all the prohibition conditions become unsatisfied.

According to this arrangement, when the input for resuming the parking operation is received, the notifications related to the prohibition conditions are displayed on the input/output device. Accordingly, it is possible to prevent a notification related to a state of the vehicle from being displayed on the input/output device in a case where the occupant does not desire to resume the parking operation. Further, the notifications related to the prohibition conditions are sequentially displayed in the display area of the input/output device. Therefore, the occupant can reliably and easily recognize the notifications related to the prohibition conditions.

Preferably, when the control device determines that the state of the vehicle is the prohibition state, the control device decelerates the vehicle so as to stop the vehicle, and after the vehicle is stopped, the control device makes the input/output device display a notification to urge the input to the brake input member in the display area.

According to this arrangement, the notification to urge the input to the brake input member can be displayed large on the input/output device. Accordingly, the occupant can easily understand that the input to the brake input member is necessary.

Preferably, the vehicle state detecting device includes at least one door open/close sensor configured to detect opening and/or closing of at least one door of the vehicle and at least one seat belt sensor configured to detect a fastening state of at least one seat belt corresponding to the door, when the door open/close sensor detects that the door of the vehicle is opened or the seat belt sensor detects that the seat belt is released, the control device determines that the state of the vehicle is the prohibition state, and in a case where the door open/close sensor detects that the door of the vehicle is opened and the seat belt sensor detects that the seat belt is released when the state of the vehicle is the prohibition state, the control device does not allow the parking operation to resume even if the input to the brake input member is detected.

According to this arrangement, when both conditions (namely, the condition that the seat belt is released and the condition that the door corresponding to the released seat belt is opened) are satisfied, the parking operation is not resumed even if the input to the brake input member is detected. Accordingly, when the occupant surely intends to alight from the vehicle, it is possible to prevent the vehicle from moving due to the resumption of the parking operation. Accordingly, it is possible to enhance the safety of the vehicle.

Preferably, the parking assist system further includes a shift actuator configured to change a shift position based on a signal from the control device, wherein in a case where the door open/close sensor detects that the door of the vehicle is opened and the seat belt sensor detects that the seat belt is released when the state of the vehicle is the prohibition state, the control device makes the shift actuator change the shift position to a parking position after stopping the movement of the vehicle.

According to this arrangement, when both conditions (namely, the condition that the seat belt is released and the condition that the door corresponding to the released seat belt is opened) are satisfied, the shift position is changed to the parking position. Accordingly, even in a case where the occupant alights from the vehicle during the parking operation, the safety of the vehicle is enhanced because the vehicle is stopped and fixed.

Preferably, the at least one door comprises a door corresponding to a driver's seat.

According to this arrangement, when the driver who should check and control the travel of the vehicle alights from the vehicle, the vehicle is stopped. Accordingly, it is possible to enhance the safety of the vehicle.

Preferably, the at least one door comprises a door corresponding to a driver's seat and a door corresponding to a seat other than the driver's seat.

According to this arrangement, when the driver (the occupant seated on the driver's seat) or the occupant seated on the seat other than the driver's seat alights from the vehicle, the vehicle is stopped. Accordingly, it is possible to enhance the safety of the vehicle.

Thus, according to one embodiment of the present invention, it is possible to provide a parking assist system that executes automatic parking and can ensure safety of a vehicle when an occupant is not in a posture to perform a braking operation of the vehicle.

### BRIEF DESCRIPTION OF THE DRAWINGS

FIG. 1 is a functional block diagram of a vehicle provided with a parking assist system according to first to third embodiments of the present invention;

FIG. 2 is a flow chart of an automatic parking process according to the first embodiment of the present invention;

FIG. 3A is a diagram showing a screen display of a touch panel during a target parking position reception process;

FIG. 3B is a diagram showing the screen display of the touch panel during a driving process;

FIG. 3C is a diagram showing the screen display of the touch panel when automatic parking is completed;

FIG. 4 is a flow chart of the driving process;

FIG. 5A is a diagram showing the screen display of the touch panel including a cancellation notification that the automatic parking has been canceled;

FIG. 5B is a diagram showing the screen display of the touch panel including a pressing notification to urge the driver to press the brake pedal;

FIG. 6 is a graph showing time changes of deceleration of the vehicle at the start thereof, in a case where an urgent deceleration process is executed (a solid line), in a case where a cancellation deceleration process or a prohibition deceleration process is executed (a broken line), and in a case other than the above two cases (one-dot chain line);

FIG. 7A is a diagram showing the screen display of the touch panel including a suspension notification that the automatic parking has been suspended and a pressing notification to urge the driver to press the brake pedal;

FIG. 7B is a diagram showing the screen display of the touch panel including a pop-up window that includes a cancellation button and a resumption button;

FIG. 7C is a diagram showing the screen display of the touch panel including a releasing notification to urge the driver to release the brake pedal when the automatic parking is resumed;

FIG. 8 is a flow chart of a driving process according to the second embodiment of the present invention;

FIG. 9A is a diagram showing the screen display of the touch panel including a stop notification;

FIG. 9B is a diagram showing the screen display of the touch panel including a pop-up window that includes a resumption button and a cancellation button;

FIG. 9C is a diagram showing the screen display of the touch panel including a pressing notification;

FIG. 10 is a flow chart of a confirmation process;

FIG. 11A is a diagram showing the screen display of the touch panel including a door notification;

FIG. 11B is a diagram showing the screen display of the touch panel including a seat belt notification;

FIG. 11C is a diagram showing the screen display of the touch panel including a door mirror notification; and

FIG. 12 is a flow chart of a driving process according to the third embodiment of the present invention.

### DESCRIPTION OF THE PREFERRED EMBODIMENT(S)

In the following, an embodiment of the present invention will be described in detail with reference to the drawings.

A parking assist system 1 is mounted on a vehicle such as an automobile provided with a vehicle control system 2 configured to make the vehicle travel autonomously.

### First Embodiment

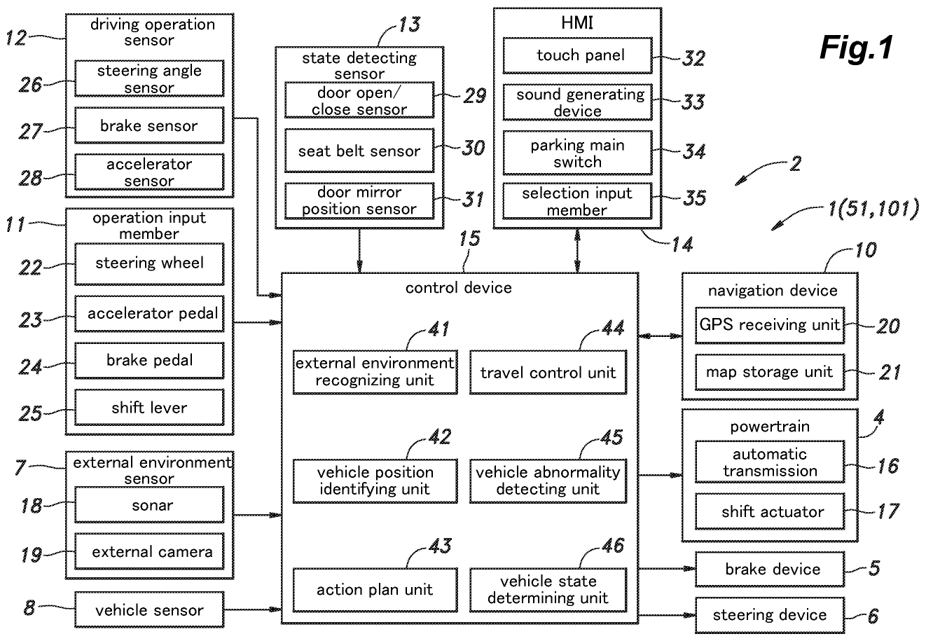

As shown in FIG. 1, the vehicle control system 2 includes a powertrain 4, a brake device 5, a steering device 6, an external environment sensor 7, a vehicle sensor 8, a navigation device 10, an operation input member 11, a driving operation sensor 12, a state detecting sensor 13, a human machine interface (HMI) 14, and a control device 15. The above components of the vehicle control system 2 are connected to each other so that signals can be transmitted therebetween via communication means such as a Controller Area Network (CAN).

The powertrain 4 is a device configured to apply a driving force to the vehicle. The powertrain 4 includes a power source and a transmission, for example. The power source includes at least one of an internal combustion engine, such as a gasoline engine and a diesel engine, and an electric motor. In the present embodiment, the powertrain 4 includes an automatic transmission 16 and a shift actuator 17 for changing a shift position of the automatic transmission 16 (a shift position of the vehicle). The brake device 5 is a device configured to apply a brake force to the vehicle. For example, the brake device 5 includes a brake caliper configured to press a brake pad against a brake rotor and an electric cylinder configured to supply an oil pressure to the brake caliper. The brake device 5 may include an electric parking brake device configured to restrict rotations of wheels via wire cables. The steering device 6 is a device for changing a steering angle of the wheels. For example, the steering device 6 includes a rack-and-pinion mechanism configured to steer (turn) the wheels and an electric motor configured to drive the rack-and-pinion mechanism. The powertrain 4, the brake device 5, and the steering device 6 are controlled by the control device 15.

The external environment sensor 7 serves as an external environment information acquisition device for detecting electromagnetic waves, sound waves, and the like from the surroundings of the vehicle to detect an object outside the vehicle and to acquire surrounding information of the vehicle. The external environment sensor 7 includes sonars 18 and external cameras 19. The external environment sensor 7 may further include a millimeter wave radar and/or a laser lidar. The external environment sensor 7 outputs a detection result to the control device 15.

Each sonar 18 consists of a so-called ultrasonic sensor. Each sonar 18 emits ultrasonic waves to the surroundings of the vehicle and captures the ultrasonic waves reflected by an object around the vehicle thereby to detect a position (distance and direction) of the object. Multiple sonars 18 are provided at each of a rear part and a front part of the vehicle. In the present embodiment, two pairs of sonars 18 are provided on a rear bumper so as to be spaced laterally from each other, two pairs of sonars 18 are provided on a front bumper so as to be spaced laterally from each other, one pair of sonars 18 is provided at a front end portion of the vehicle such that the two sonars 18 forming the pair are provided on left and right side faces of the front end portion of the vehicle, and one pair of sonars 18 is provided at a rear end portion of the vehicle such that the two sonars 18 forming the pair are provided on left and right side faces of the rear end portion of the vehicle. That is, the vehicle is provided with six pairs of sonars 18 in total. The sonars 18 provided on the rear bumper mainly detect positions of objects behind the vehicle. The sonars 18 provided on the front bumper mainly detect positions of objects in front of the vehicle. The sonars 18 provided at the left and right side faces of the front end portion of the vehicle detect positions of objects on left and right outsides of the front end portion of the vehicle, respectively. The sonars 18 provided at the left and right side faces of the rear end portion of the vehicle detect positions of objects on left and right outsides of the rear end portion of the vehicle, respectively.

The external cameras 19 are devices configured to capture images around the vehicle. Each external camera 19 consists of a digital camera using a solid imaging element such as a CCD or a CMOS, for example. The external cameras 19 include a front camera for capturing an image in front of the vehicle and a rear camera for capturing an image to the rear of the vehicle. The external cameras 19 may include a pair of left and right side cameras that are provided in the vicinity of the door mirrors of the vehicle to capture images on left and right sides of the vehicle.

The vehicle sensor 8 includes a vehicle speed sensor configured to detect the speed of the vehicle, an acceleration sensor configured to detect the acceleration of the vehicle, a yaw rate sensor configured to detect the angular velocity around a vertical axis of the vehicle, and a direction sensor configured to detect the direction of the vehicle. For example, the yaw rate sensor consists of a gyro sensor.

The navigation device 10 is a device configured to obtain a current position of the vehicle and provides route guidance to a destination and the like. The navigation device 10 includes a GPS receiving unit 20 and a map storage unit 21. The GPS receiving unit 20 identifies a position (latitude and longitude) of the vehicle based on a signal received from an artificial satellite (positioning satellite). The map storage unit 21 consists of a known storage device such as a flash memory or a hard disk, and stores map information.

The operation input member 11 is provided in a vehicle cabin to receive an input operation performed by the occupant (user) to control the vehicle. The operation input member 11 includes a steering wheel 22, an accelerator pedal 23, a brake pedal 24 (brake input member), and a shift lever 25 (a shift member). The shift lever 25 is configured to receive an operation for selecting the shift position of the vehicle.

The driving operation sensor 12 detects an operation amount of the operation input member 11. The driving operation sensor 12 includes a steering angle sensor 26 configured to detect a steering angle of the steering wheel 22, a brake sensor 27 configured to detect a pressing amount of the brake pedal 24, and an accelerator sensor 28 configured to detect a pressing amount of the accelerator pedal 23. The driving operation sensor 12 outputs a detected operation amount to the control device 15.

The state detecting sensor 13 is a sensor configured to detect a change in a state of the vehicle according to an operation by the occupant. The operation by the occupant detected by the state detecting sensor 13 includes an operation indicating an alighting intention (intention to alight from the vehicle) of the occupant and an operation indicating absence of an intention of the occupant to check the surroundings of the vehicle during an autonomous parking operation or an autonomous unparking operation. The state detecting sensor 13 includes, as sensors for detecting the operation indicating the alighting intention, a door open/close sensor 29 configured to detect opening and/or closing of a door of the vehicle and a seat belt sensor 30 configured to detect a fastening state of a seat belt. The state detecting sensor 13 includes, as a sensor to detect the operation corresponding to the abdicating intention, a door mirror position sensor 31 configured to detect a position of a door mirror. The state detecting sensor 13 outputs a signal indicating a detected change in the state of the vehicle to the control device 15.

The HMI 14 is an input/output device for receiving an input operation by the occupant and notifying the occupant of various kinds of information by display and/or voice. The HMI 14 includes, for example, a touch panel 32 that includes a display screen such as a liquid crystal display or an organic EL display and is configured to receive the input operation by the occupant, a sound generating device 33 such as a buzzer or a speaker, a parking main switch 34, and a selection input member 35. The parking main switch 34 receives the input operation by the occupant to execute selected one of an automatic parking process (autonomous parking operation) and an automatic unparking process (autonomous unparking operation). The parking main switch 34 is a so-called momentary switch that is turned on only while a pressing operation (pushing operation) is performed by the occupant. The selection input member 35 receives a selection operation by the occupant related to selection of the automatic parking process and the automatic unparking process. The selection input member 35 may consist of a rotary select switch, which preferably requires pressing as the selection operation.

The control device 15 consists of an electronic control unit (ECU) that includes a CPU, a nonvolatile memory such as a ROM, a volatile memory such as a RAM, and the like. The CPU executes operation processing according to a program so that the control device 15 executes various types of vehicle control. The control device 15 may consist of one piece of hardware, or may consist of a unit including multiple pieces of hardware. Further, the functions of the control device 15 may be at least partially executed by hardware such as an LSI, an ASIC, and an FPGA, or may be executed by a combination of software and hardware.

Further, the control device 15 executes an arithmetic process according to a program and thereby performs a conversion process of an image (video) captured by the external cameras 19 so as to generate a look-down image corresponding to a plan view of the vehicle and its surrounding area and a bird's-eye image corresponding to a three-dimensional image of the vehicle and a part of its surrounding area positioned in the travel direction as viewed from above. The control device 15 may generate the look-down image by combining the images of the front camera, the rear camera, and the left and right side cameras, and may generate the bird's-eye image by combining the image captured by the front camera or the rear camera facing the travel direction and the images captured by the left and right side cameras.

The parking assist system 1 is a system for executing the so-called automatic parking process and the so-called automatic unparking process, in which a vehicle is moved autonomously to a prescribed target position (a target parking position or a target unparking position) selected by the occupant so as to park or unpark the vehicle.

The parking assist system 1 includes the control device 15, the brake pedal 24 as a brake input member, the driving operation sensor 12, and the state detecting sensor 13.

The control device 15 controls the powertrain 4, the brake device 5, and the steering device 6 so as to execute an autonomous parking operation to move the vehicle autonomously to a target parking position and park the vehicle at the target parking position and an autonomous unparking operation to move the vehicle autonomously to a target unparking position and unpark the vehicle at the target unparking position. In order to execute such operations, the control device 15 includes an external environment recognizing unit 41, a vehicle position identifying unit 42, an action plan unit 43, a travel control unit 44, a vehicle abnormality detecting unit 45, and a vehicle state determining unit 46.

The external environment recognizing unit 41 recognizes an obstacle (for example, a parked vehicle or a wall) that is present around the vehicle based on the detection result of the external environment sensor 7, and thereby obtains information about the obstacle. Further, the external environment recognizing unit 41 analyzes the images captured by the external cameras 19 based on a known image analysis method such as pattern matching, and thereby determines whether a wheel stopper or an obstacle is present, and obtains the size of the wheel stopper or the obstacle in a case where the wheel stopper or the obstacle is present. Further, the external environment recognizing unit 41 may compute a distance to the obstacle based on signals from the sonars 18 to obtain the position of the obstacle.

Also, by the analysis of the detection result of the external environment sensor 7 (more specifically, by the analysis of the images captured by the external cameras 19 based on a known image analysis method such as pattern matching), the external environment recognizing unit 41 can acquire, for example, a lane on a road delimited by road signs and a parking space delimited by white lines and the like provided on a surface of a road, a parking lot, and the like.

The vehicle position identifying unit 42 identifies the position of the vehicle (the own vehicle) based on a signal from the GPS receiving unit 20 of the navigation device 10. Further, the vehicle position identifying unit 42 may obtain the vehicle speed and the yaw rate from the vehicle sensor 8, in addition to the signal from the GPS receiving unit 20, and identify the position and posture of the vehicle by the so-called inertial navigation.

The travel control unit 44 controls the powertrain 4, the brake device 5, and the steering device 6 based on a travel control instruction from the action plan unit 43 to make the vehicle travel.

The vehicle abnormality detecting unit 45 detects an abnormality of the vehicle (hereinafter referred to as “vehicle abnormality”) based on signals from various devices and sensors. The vehicle abnormality detected by the vehicle abnormality detecting unit 45 includes failure of various devices necessary for driving the vehicle (for example, the powertrain 4, the brake device 5, and the steering device 6) and failure of various sensors necessary for making the vehicle travel autonomously (for example, the external environment sensor 7, the vehicle sensor 8, and the GPS receiving unit 20). Further, the vehicle abnormality includes failure of the HMI 14.

In the present embodiment, the vehicle abnormality detecting unit 45 can detect an abnormality in the screen display of the touch panel 32 based on at least a signal from the touch panel 32.

The vehicle state determining unit 46 acquires the state of the vehicle based on signals from various sensors provided in the vehicle, and determines whether the vehicle is in a prohibition state in which the autonomous movement (namely, the autonomous parking operation or the autonomous unparking operation) of the vehicle should be prohibited. The vehicle state determining unit 46 determines that the vehicle is in the prohibition state when the occupant performs a driving operation (override operation) of the operation input member 11. The override operation is an operation to override (cancel) the autonomous movement (namely, the autonomous parking operation or the autonomous unparking operation) of the vehicle.

More specifically, the vehicle state determining unit 46 may determine the initiation of the override operation when the pressing amount of the brake pedal 24 acquired (detected) by the brake sensor 27 has reached or exceeded a prescribed threshold (hereinafter referred to as “pressing threshold”). Additionally or alternatively, the vehicle state determining unit 46 may determine the initiation of the override operation when a pressing amount of the accelerator pedal 23 acquired (detected) by the accelerator sensor 28 has reached or exceeded a prescribed threshold. The vehicle state determining unit 46 may also determine the initiation of the override operation when a changing rate of the steering angle obtained (detected) by the steering angle sensor 26 has reached or exceeded a prescribed threshold.

Further, the vehicle state determining unit 46 determines, based on the detection result of the state detecting sensor 13, that the vehicle is in the prohibition state when the vehicle is in a state that reflects the alighting intention (intention to alight from the vehicle) of the occupant. More specifically, when the door open/close sensor 29 detects that the door is opened, the vehicle state determining unit 46 determines that the vehicle is in the prohibition state. Also, when the seat belt sensor 30 detects that the seat belt is released, the vehicle state determining unit 46 determines that the vehicle is in the prohibition state.

Further, the vehicle state determining unit 46 determines that, based on the detection result of the state detecting sensor 13, that the vehicle is in the prohibition state when the vehicle is in a state that reflects the absence of intention of the occupant to check the surroundings of the vehicle. More specifically, the vehicle state determining unit 46 determines that the vehicle is in the prohibition state when the door mirror position sensor 31 detects that the door mirror is retracted.

Also, when it is determined, based on the detection result of the state detecting sensor 13, that the door is opened and the seat belt is released, the vehicle state determining unit 46 determines that the alighting intention of the occupant is certain and that the vehicle is in a cancellation state in which the autonomous movement (namely, the autonomous parking operation or the autonomous unparking operation) of the vehicle should be canceled. In addition, the vehicle state determining unit 46 may determine that the vehicle is in the cancellation state when there is an input to a cancellation button displayed on the touch panel 32 while the vehicle is moving autonomously.

In the present embodiment, each vehicle seat provided in the vehicle cabin is provided with a seating sensor configured to detect seating of the occupant. The vehicle state determining unit 46 determines a seating position of the occupant (namely, the vehicle state determining unit 46 identifies the vehicle seat on which the occupant is seated) based on a signal from the seating sensor, and determines that the vehicle is in the cancellation state when the seat belt at the seating position is released and the door near the seating position is opened.

As described above, the driving operation sensor 12 and the state detecting sensor 13 each correspond to the vehicle state detecting device configured to detect the state of the vehicle (for example, the prohibition state in which the autonomous parking operation or the autonomous unparking operation of the vehicle should be prohibited). The vehicle state determining unit 46 determines the state of the vehicle based on the detection results of the driving operation sensor 12 and the state detecting sensor 13. By using the driving operation sensor 12, it is possible to easily detect the override operation of the occupant. By using the state detecting sensor 13, it is possible to easily detect an alighting operation of the user and a change in the state of the vehicle according to an extending/retracting operation of the door mirror.

The action plan unit 43 executes the automatic parking process (autonomous parking operation) or the automatic unparking process (autonomous unparking operation) when the vehicle is in a prescribed state and the HMI 14 or the parking main switch 34 receives a prescribed input by the user, which corresponds to a request for the automatic parking process or the automatic unparking process. More specifically, the action plan unit 43 executes the automatic parking process in a case where a prescribed input corresponding to the automatic parking process is performed when the vehicle is stopped or the vehicle is traveling at a low speed equal to or less than a prescribed vehicle speed (a vehicle speed at which a parking position candidate can be searched for). The action plan unit 43 executes the automatic unparking process (parallel unparking process) in a case where a prescribed input corresponding to the automatic unparking process is performed when the vehicle is stopped. The selection of the process to be executed (the automatic parking process or the automatic unparking process) may be made by the action plan unit 43 based on the state of the vehicle. Alternatively, the above selection may be made by the occupant via the touch panel 32 or the selection input member 35. When executing the automatic parking process, the action plan unit 43 first makes the touch panel 32 display a parking search screen for setting the target parking position. After the target parking position is set, the action plan unit 43 makes the touch panel 32 display a parking screen. When executing the automatic unparking process, the action plan unit 43 first makes the touch panel 32 display an unparking search screen for setting the target unparking position. After the target unparking position is set, the action plan unit 43 makes the touch panel 32 display an unparking screen.

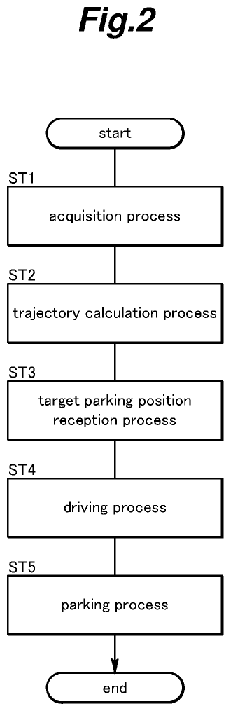

In the following, the automatic parking process will be described with reference to FIG. 2. The action plan unit 43 first executes an acquisition process (step ST1) to acquire one or more parking spaces, if any. More specifically, in a case where the vehicle is stopped, the action plan unit 43 first makes the touch panel 32 of the HMI 14 display a notification that instructs the occupant to move the vehicle straight. While the occupant sitting in the driver's seat (hereinafter referred to as “driver”) is moving the vehicle straight, the external environment recognizing unit 41 acquires, based on a signal from the external environment sensor 7, a position and size of each detected obstacle and positions of the white lines provided on the road surface. The external environment recognizing unit 41 extracts, based on the acquired position and size of the obstacle and the acquired positions of the white lines, one or more undelimited parking spaces and one or more delimited parking spaces, if any (hereinafter, the undelimited parking spaces and the delimited parking spaces will be collectively referred to as “parking spaces”). Each undelimited parking space is a space that is not delimited by the white lines or the like, has a size sufficient to park the vehicle, and is available (namely, there is no obstacle therein). Each delimited parking space is a space that is delimited by the white lines or the like, has a size sufficient to park the vehicle, and is available (namely, another vehicle (vehicle other than the own vehicle) is not parked).

Next, the action plan unit 43 executes a trajectory calculation process (step ST2) to calculate a trajectory of the vehicle from a current position of the vehicle to each extracted parking space. In a case where the trajectory of the vehicle can be calculated for a certain parking space, the action plan unit 43 sets the parking space as a parking position candidate where the vehicle can be parked, and make the touch panel 32 display the parking position candidate on the screen (the parking search screen). In a case where the trajectory of the vehicle cannot be calculated due to the presence of the obstacle, the action plan unit 43 does not set the parking space as a parking position candidate and does not make the touch panel 32 display the parking space on the screen. When the action plan unit 43 sets multiple parking position candidates (namely, multiple parking places for which the trajectory of the vehicle can be calculated), the action plan unit 43 makes the touch panel 32 display these parking position candidates.

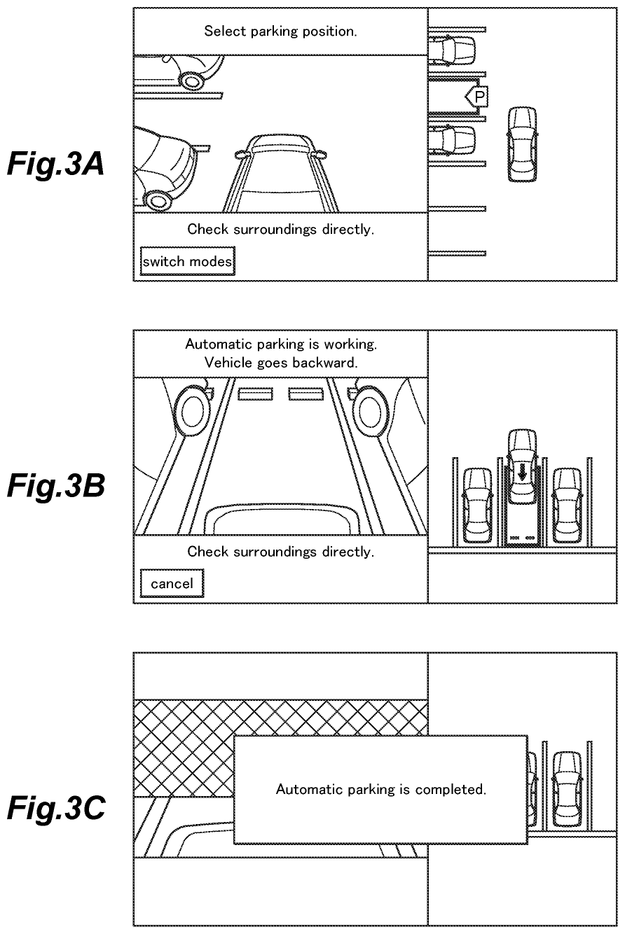

Next, the action plan unit 43 executes a target parking position reception process (step ST3) to receive a selection operation performed by the occupant to select the target parking position, which is a parking position where the occupant wants to park the vehicle, and is selected from the one or more parking position candidates displayed on the touch panel 32. More specifically, the action plan unit 43 makes the touch panel 32 display the look-down image and the bird's-eye image in the travel direction on the parking search screen shown in FIG. 3A. When the action plan unit 43 acquires at least one parking position candidate, the action plan unit 43 makes the touch panel 32 display a frame that indicates the parking position candidate and an icon that corresponds to the frame in at least one of the look-down image and the bird's-eye image (in the look-down image in FIG. 3A) in an overlapping manner. The icon consists of a symbol indicating the parking position candidate (see “P” in FIG. 3A). Also, the action plan unit 43 makes the touch panel 32 display the parking search screen including a notification that instructs the driver to stop the vehicle and select the target parking position, so that the touch panel 32 receives the selection operation of the target parking position. The selection operation of the target parking position may be performed via the touch panel 32, or may be performed via the selection input member 35.

After the vehicle is stopped and the target parking position is selected by the driver, the action plan unit 43 makes the touch panel 32 switch the screen from the parking search screen to the parking screen. As shown in FIG. 3B, the parking screen is a screen in which an image in the travel direction of the vehicle (hereinafter referred to as “travel direction image”) is displayed on the left half of the touch panel 32 and the look-down image including the vehicle and its surrounding area is displayed on the right half thereof. At this time, the action plan unit 43 may make the touch panel 32 display a thick frame that indicates the target parking position selected from the parking position candidates and an icon that corresponds to the thick frame such that the thick frame and the icon overlap with the look-down image. This icon consists of a symbol indicating the target parking position, and is shown in a color different from the symbol indicating the parking position candidate.

After the target parking position is selected and the screen of the touch panel 32 is switched to the parking screen, the action plan unit 43 executes a driving process (step ST4) to make the vehicle travel along the calculated trajectory. At this time, the action plan unit 43 controls the vehicle based on the position of the vehicle acquired by the GPS receiving unit 20 and the signals from the external cameras 19, the vehicle sensor 8, and the like so that the vehicle travels along the calculated trajectory. At this time, the action plan unit 43 controls the powertrain 4, the brake device 5, and the steering device 6 so as to execute a switching operation for switching the travel direction of the vehicle (a reversing operation for reversing the travel direction of the vehicle). The switching operation may be executed repeatedly, or may be executed only once.

During the driving process, the action plan unit 43 may acquire the travel direction image from the external cameras 19 and make the touch panel 32 display the acquired travel direction image on the left half thereof. For example, as shown in FIG. 3B, when the vehicle is moving backward, the action plan unit 43 may make the touch panel 32 display an image to the rear of the vehicle captured by the external cameras 19 on the left half thereof. While the action plan unit 43 is executing the driving process, the surrounding image of the vehicle (the own vehicle) in the look-down image displayed on the right half of the touch panel 32 changes along with the movement of the vehicle. When the vehicle reaches the target parking position, the action plan unit 43 stops the vehicle and ends the driving process.

When the driving process ends, the action plan unit 43 executes a parking process (step ST5). In the parking process, the action plan unit 43 first drives the shift actuator 17 to set the shift position (shift range) to a parking position (parking range). Thereafter, the action plan unit 43 drives the parking brake device, and makes the touch panel 32 display a pop-up window (see FIG. 3C) indicating that the automatic parking of the vehicle has been completed. The pop-up window may be displayed on the screen of the touch panel 32 for a prescribed period. Thereafter, the action plan unit 43 may make the touch panel 32 switch the screen to an operation screen of the navigation device 10 or a map screen.

In the parking process, there may be a case where the shift position cannot be changed to the parking position because of an abnormality of the shift actuator 17 or a case where the parking brake device cannot be driven because of an abnormality of the parking brake device. In these cases, the action plan unit 43 may make the touch panel 32 display the cause of the abnormality on the screen thereof.

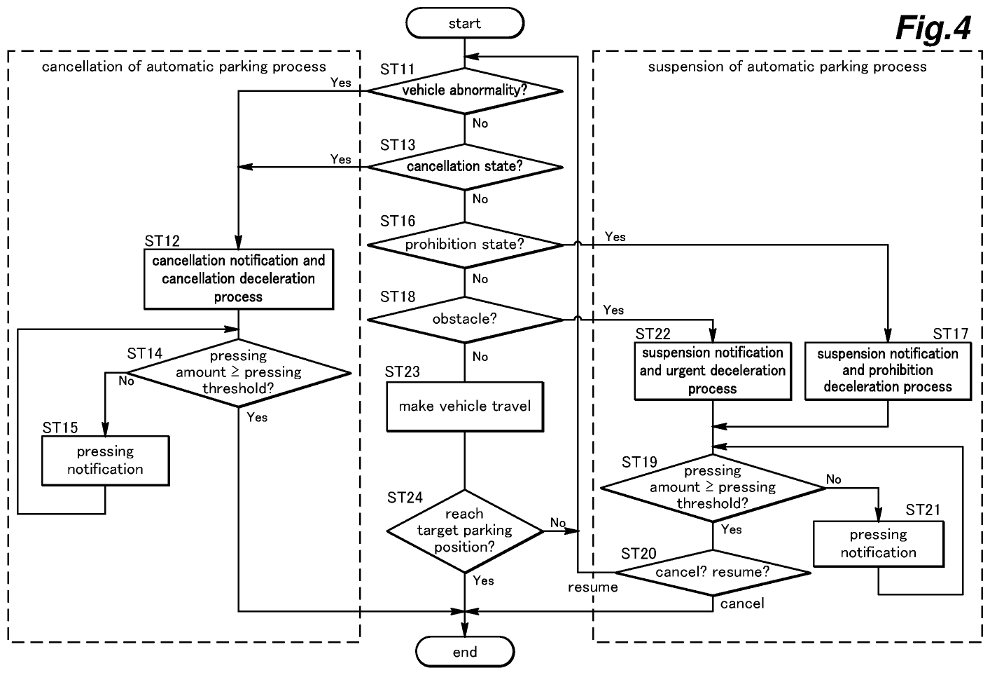

Next, details of the driving process executed by the action plan unit 43 will be described with reference to FIG. 4.

As shown in FIG. 4, in the first step ST11 of the driving process, the action plan unit 43 determines whether the vehicle abnormality detecting unit 45 detects a vehicle abnormality such as an abnormality in the screen display of the touch panel 32. Step ST12 is executed if a vehicle abnormality is detected, otherwise step ST13 is executed.

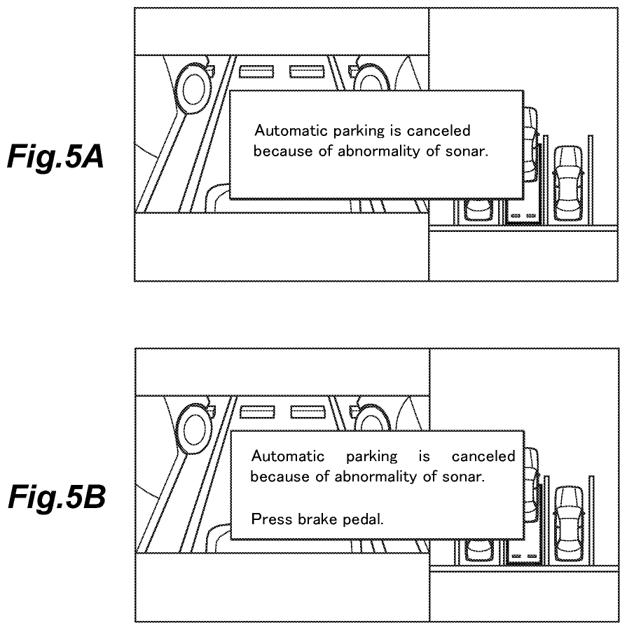

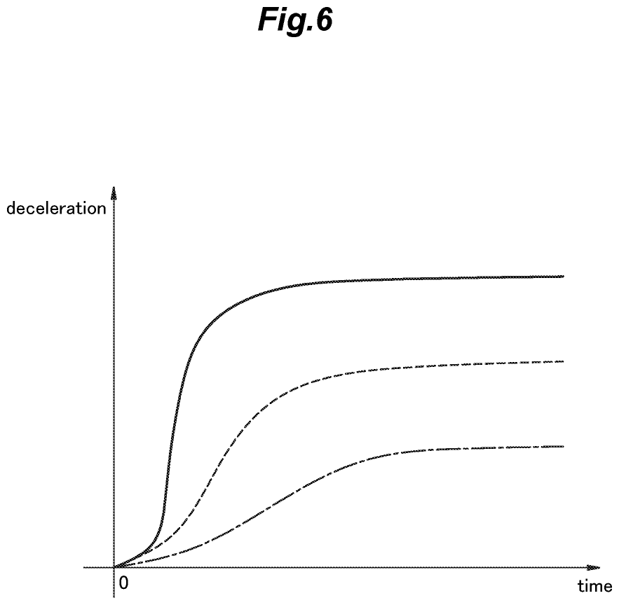

In step ST12, the action plan unit 43 makes the touch panel 32 display a pop-up window including a cancellation notification that the automatic parking process is canceled (see FIG. 5A). At this time, the action plan unit 43 may make the touch panel 32 display the cause of the cancellation of the automatic parking process (for example, an abnormality of the sonar 18 or the like) in the pop-up window. At the same time, the action plan unit 43 makes the sound generating device 33 generate a warning sound or a voice notifying that the automatic parking process is canceled. Thereafter, the action plan unit 43 executes a cancellation deceleration process to decelerate the vehicle so as to stop the vehicle. More specifically, in the cancellation deceleration process, the action plan unit 43 decelerates the vehicle at a prescribed deceleration (hereinafter referred to as “normal deceleration upper limit”) or less. FIG. 6 illustrates a time change of the deceleration at this time with a broken line. At this time, the action plan unit 43 limits a change rate of the deceleration (namely, a jerk) to a prescribed upper limit (hereinafter referred to as “normal change rate upper limit”) or less. The action plan unit 43 executes step ST14 when the vehicle speed becomes sufficiently low.

In step ST14, the action plan unit 43 acquires the pressing amount of the brake pedal 24, and determines whether the pressing amount of the brake pedal 24 is equal to or more than the pressing threshold. When the pressing amount of the brake pedal 24 is equal to or more than the pressing threshold, the driving process ends. When the pressing amount of the brake pedal 24 is less than the pressing threshold (that is, when the pressing of the brake pedal 24 is insufficient), the action plan unit 43 executes step ST15.

In step ST15, the action plan unit 43 makes the touch panel 32 of the HMI 14 display a pressing notification to urge the driver to press the brake pedal 24. In the present embodiment, the action plan unit 43 makes the touch panel 32 display the pressing notification in the pop-up window including the cancellation notification that the automatic parking process is canceled (see FIG. 5B). At this time, the action plan unit 43 may urge the driver to press the brake pedal 24 by making the sound generating device 33 generate a warning sound or a voice. When the pressing notification is completed, the action plan unit 43 executes step ST14.

In step ST13, the vehicle state determining unit 46 determines whether the state of the vehicle is the cancellation state. The action plan unit 43 executes step ST12 in a case where it is determined that the state of the vehicle is in the cancellation state, and otherwise the action plan unit 43 executes step ST16.

In step ST16, the vehicle state determining unit 46 determines whether the state of the vehicle is the prohibition state. The action plan unit 43 executes step ST17 in a case where it is determined that the state of the vehicle is in the prohibition state, and otherwise the action plan unit 43 executes step ST18.

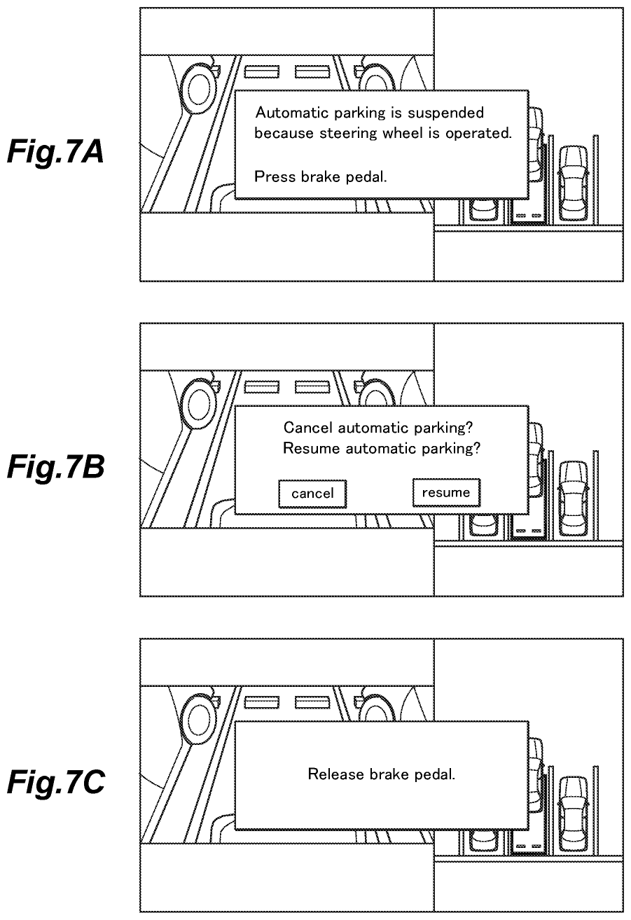

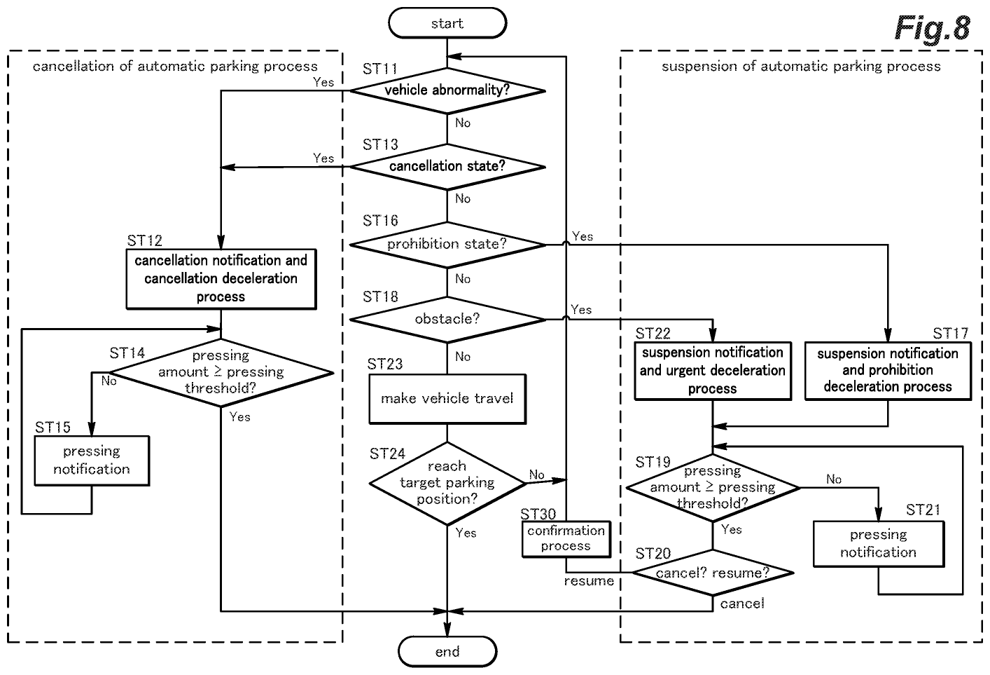

In step ST17, the action plan unit 43 makes the touch panel 32 display a pop-up window including a suspension notification that the automatic parking process is suspended. At this time, the action plan unit 43 may make the touch panel 32 display the cause of the suspension of the automatic parking process (for example, detection of the operation on the steering wheel 22) in the pop-up window (see FIG. 7A). Thereafter, the action plan unit 43 executes a prohibition deceleration process, which is the same as the cancellation deceleration process in step ST12, to decelerate the vehicle so as to stop the vehicle. The action plan unit 43 executes step ST19 when the vehicle speed becomes sufficiently low.

In step ST19, the action plan unit 43 acquires the pressing amount of the brake pedal 24, and determines whether the pressing amount of the brake pedal 24 is equal to or more than the pressing threshold. When the pressing amount of the brake pedal 24 is equal to or more than the pressing threshold, the action plan unit 43 executes step ST20. When the pressing amount of the brake pedal 24 is less than the pressing threshold, the action plan unit 43 executes step ST21.

In step ST20, the action plan unit 43 makes the touch panel 32 display a pop-up window including a cancellation button and a resumption button (see FIG. 7B). When an input (touch) to the cancellation button is detected on the touch panel 32, the action plan unit 43 ends the driving process and executes the parking process. When an input to the resumption button is detected on the touch panel 32, the action plan unit 43 executes the first step ST11 of the driving process.

In step ST21, the action plan unit 43 makes the touch panel 32 display the pressing notification to urge the driver to press the brake pedal 24. At this time, when the pop-up window including the suspension notification that the automatic parking process is suspended is displayed on the touch panel 32, the action plan unit 43 may make the touch panel 32 display the pressing notification in the pop-up window (see FIG. 7A). When the display of the pressing notification is completed, the action plan unit 43 executes step ST19.

In step ST18, the action plan unit 43 determines a travel direction of the vehicle and a distance to be traveled (travel distance) for a prescribed time (hereinafter referred to as “travel time”) based on the calculated trajectory. The action plan unit 43 may determine the travel distance based on a product of the vehicle speed and the travel time. Thereafter, the action plan unit 43 determines presence/absence of an obstacle within the travel distance based on the travel direction image captured by the external cameras 19 and the signals from the sonars 18. When the action plan unit 43 determines that the obstacle is present in the travel direction of the vehicle within the travel distance, that is, when the action plan unit 43 determines that a collision may occur if the vehicle moves by the travel distance, the action plan unit 43 executes step ST22. When the action plan unit 43 determines that no obstacle is present in the travel direction of the vehicle within the travel distance, the action plan unit 43 executes step ST23.

In step ST22, as in step ST17, the action plan unit 43 makes the touch panel 32 display a pop-up window including the suspension notification that the automatic parking process is suspended. Thereafter, the action plan unit 43 executes an urgent deceleration process to decelerate the vehicle so as to stop the vehicle. In the urgent deceleration process, the action plan unit 43 decelerates the vehicle at a prescribed deceleration (hereinafter referred to as “urgent deceleration upper limit”) or less. FIG. 6 illustrates a time change of the deceleration at this time with a solid line. At this time, the action plan unit 43 limits a change rate of the deceleration to a prescribed upper limit (hereinafter referred to as “urgent change rate upper limit”) or less. The urgent deceleration upper limit is set to be larger than the normal deceleration upper limit. Also, the urgent change rate upper limit is set to be larger than the normal change rate upper limit. The action plan unit 43 executes step ST19 when the vehicle speed becomes sufficiently low.

In step ST23, the action plan unit 43 makes the vehicle travel along the calculated trajectory for the travel time so as to move the vehicle by the travel distance. During the movement of the vehicle, as shown in FIG. 3B, the action plan unit 43 may make the touch panel 32 display the cancellation button to cancel the automatic parking process together with the bird's-eye image and the look-down image. In step ST23, the action plan unit 43 may prohibit the vehicle from moving when the brake pedal 24 is pressed, and may make the touch panel 32 display a releasing notification to urge the driver to release the brake pedal 24 (see FIG. 7C). Thereby, the driver can easily understand that the movement of the vehicle will be resumed when the driver releases the brake pedal 24.

In step ST23, when the distance to the target parking position becomes equal to or less than a prescribed threshold or when the distance to a stop position where the vehicle should stop in the switching operation becomes equal to or less than a prescribed threshold, the action plan unit 43 executes a movement deceleration process to decelerate the vehicle so as to stop the vehicle at the target parking position or the stop position. The action plan unit 43 sets the upper limit of the deceleration of the vehicle in this movement deceleration process (that is, the upper limit of the deceleration of the vehicle to stop the vehicle at the target parking position or the stop position) to a movement deceleration upper limit, which is set in consideration of safety. The movement deceleration upper limit is set to a value smaller than the normal deceleration upper limit. Further, the action plan unit 43 sets the upper limit of the change rate of the deceleration of the vehicle in this movement deceleration process to a prescribed movement change rate upper limit. The movement change rate upper limit is set to a value smaller than the normal change rate upper limit. FIG. 6 illustrates a time change of the deceleration when the distance to the target parking position is equal to or less than the prescribed threshold with a one-dot chain line. After making the vehicle travel along the calculated trajectory for the travel time, the action plan unit 43 executes step ST24.

In step ST24, the action plan unit 43 acquires the position of the vehicle, and determines whether the position of the vehicle matches the target parking position, that is, whether the vehicle has reached the target parking position. When the vehicle has reached the target parking position, the action plan unit 43 drives the brake device 5 to stop the vehicle at the target parking position. When the vehicle has not reached the target parking position, the action plan unit 43 executes the first step ST11 of the driving process.

Next, the operation of the parking assist system 1 configured as described above will be further described. In the parking assist system 1, as shown in the left half of FIG. 4, when the vehicle abnormality is detected (Yes in step ST11) or when the state of the vehicle is the cancellation state (Yes in step ST13) during the automatic parking process, the vehicle is decelerated and stopped after the touch panel 32 displays the cancellation notification that the automatic parking process is canceled (step ST12). Thereafter, in a case where the brake pedal 24 is not sufficiently pressed, the touch panel 32 displays the pop-up window including the pressing notification to urge the driver to press the brake pedal 24. When the brake pedal 24 is pressed, the driving process is completed and the parking process is executed. During the parking process, the action plan unit 43 controls the shift actuator 17 to set the shift position to the parking position. Thereafter, the action plan unit 43 operates the parking brake device to fix the vehicle. As described above, in the driving process, when the vehicle abnormality including the abnormality of the touch panel 32 is detected or when the state of the vehicle is the cancellation state (more specifically, when the seat belt is released and the door is opened or when there is an input to the cancellation button displayed on the touch panel 32 during the movement of the vehicle), the driving operation is canceled.

As shown in the right half of FIG. 4, when the state of the vehicle is the prohibition state (Yes in step ST16) or when the action plan unit 43 determines that there is an obstacle (Yes in step ST18), the vehicle is decelerated and stopped after the touch panel 32 displays the suspension notification that the automatic parking process is suspended (step ST17, ST22). Thereafter, if the brake pedal 24 is not sufficiently pressed, the touch panel 32 displays the pop-up window including the pressing notification to urge the driver to press the brake pedal 24. When the brake pedal 24 is pressed, the touch panel 32 displays the resumption button and the cancellation button so as to be able to receive an input to resume the driving process (step ST20). When the resumption button is pressed, the action plan unit 43 executes the first step ST11 of the driving process, so that the driving process is resumed. When the cancellation button is pressed, the driving process ends and the parking process is executed to fix the vehicle. Thus, during the driving process, when the vehicle is in the prohibition state or when the action plan unit 43 determines that there is an obstacle, the driving process is suspended.

When the vehicle abnormality is not detected (No in step ST11), the state of the vehicle is not the cancellation state nor the prohibition state (No in step ST13 and ST16), and the action plan unit 43 determines that there is no obstacle (No in step ST18), the vehicle continues traveling until the vehicle reaches the target parking position (step ST23). When the vehicle reaches the target parking position (Yes in step ST24), the driving process ends, and then the parking process is executed to fix the vehicle.

Next, the effect of the parking assist system 1 configured as described above will be further described. In a case where it is determined that the state of the vehicle is the prohibition state (Yes in step ST16) or in a case where it is determined that the obstacle is present (Yes in step ST18), the autonomous parking operation is allowed to resume on condition that the occupant presses the brake pedal 24 (Yes in step ST19). By including the pressing of the brake pedal 24 in the condition for resuming the autonomous parking operation, it is possible to resume the autonomous parking operation after the occupant checks the surroundings and takes a posture to stop the vehicle appropriately. Accordingly, the occupant such as a driver is likely to press the brake pedal 24 when the movement of the vehicle should be suspended during the autonomous parking operation. Therefore, it is possible to enhance the safety of the vehicle during the autonomous parking operation.

Furthermore, after the state of the vehicle becomes the prohibition state and then the vehicle is stopped, the autonomous parking operation is resumed on condition that the occupant performs two inputs, namely, the pressing of the brake pedal 24 (Yes in step ST19) and the input for resuming the autonomous parking operation (the push of the resumption button, “resume” in step ST20). Accordingly, it is possible to prevent the autonomous parking operation from being resumed due to an erroneous operation by the occupant, and thereby to ensure safety when the autonomous parking operation is resumed.

In addition, after it is determined that the state of the vehicle is the prohibition state or that the obstacle is present and then the vehicle is stopped, in a case where it is determined that the pressing of the brake pedal 24 is insufficient, the touch panel 32 displays the pop-up window including the pressing notification to urge the pressing of the brake pedal 24 (step ST21). Thereby, the occupant can easily understand that the pressing of the brake pedal 24 is necessary for resuming the autonomous parking operation.

Also, after it is determined that the state of the vehicle is the prohibition state or that the obstacle is present and then the vehicle is stopped, in a case where the pressing amount of the brake pedal 24 becomes equal to or more than the pressing threshold (Yes in step ST19) and the resumption button is pushed (Yes in step ST20), the autonomous parking operation is resumed. After the autonomous parking operation is resumed, when the occupant such as a driver releases the brake pedal 24, the movement of the vehicle is resumed (step ST23). In this way, since the movement of the vehicle is resumed when the brake pedal 24 is released, the driver can easily understand the timing when the movement of the vehicle resumes. Therefore, the occupant can check the surroundings when the movement of the vehicle is resumed, so that the safety of the vehicle is enhanced.

In a case where the vehicle abnormality is detected (Yes in step ST11), the vehicle is stopped. Thereafter, in a case where the pressing of the brake pedal 24 is insufficient, the pressing notification to urge the pressing of the brake pedal 24 is displayed (step ST15). In this way, in a case where the vehicle abnormality is detected, like in a case where the state of the vehicle is the cancellation state or the prohibition state or in a case where it is determined that the obstacle is present, the pressing notification is executed (step ST15, ST21). Thereby, it is possible to execute consistent notifications to the occupant and to simply compose the notification screen of the touch panel 32.

When the vehicle abnormality is detected or the state of the vehicle is the cancellation state, the vehicle is stopped. Thereafter, in a case where the brake pedal 24 is pressed, the driving process is completed and the parking process is executed. In the parking process, the action plan unit 43 drives the shift actuator 17 so as to make the shift actuator 17 change the shift position to the parking position, and drives the parking brake device. Accordingly, when the vehicle abnormality is present or when the occupant releases the seat belt and opens the door so as to alight from the vehicle, the vehicle can be stopped more reliably, so that the safety of the vehicle can be enhanced. In addition, in a case where the vehicle abnormality is detected or the vehicle is in the cancellation state, unlike in a case where the state of the vehicle is the prohibition state, the autonomous parking operation cannot be resumed. Therefore, when the vehicle abnormality is present or the occupant alights from the vehicle, it is possible to prevent the vehicle from moving, so that the safety of the vehicle is enhanced.

### Second Embodiment

The parking assist system 51 according to the second embodiment is different from the parking assist system 1 according to the first embodiment in that the parking assist system 51 includes the external cameras 19 as the surrounding information acquisition device configured to acquire surrounding information of the vehicle. Further, the parking assist system 51 according to the second embodiment is different from the parking assist system 1 according to the first embodiment in the screen display of the touch panel 32 in step ST17 and in a confirmation process executed after step ST20. The parking assist system 51 according to the second embodiment is similar to the parking assist system 1 according to the first embodiment in other processes. In the following, first, the screen display of the touch panel 32 in step ST17 will be described.

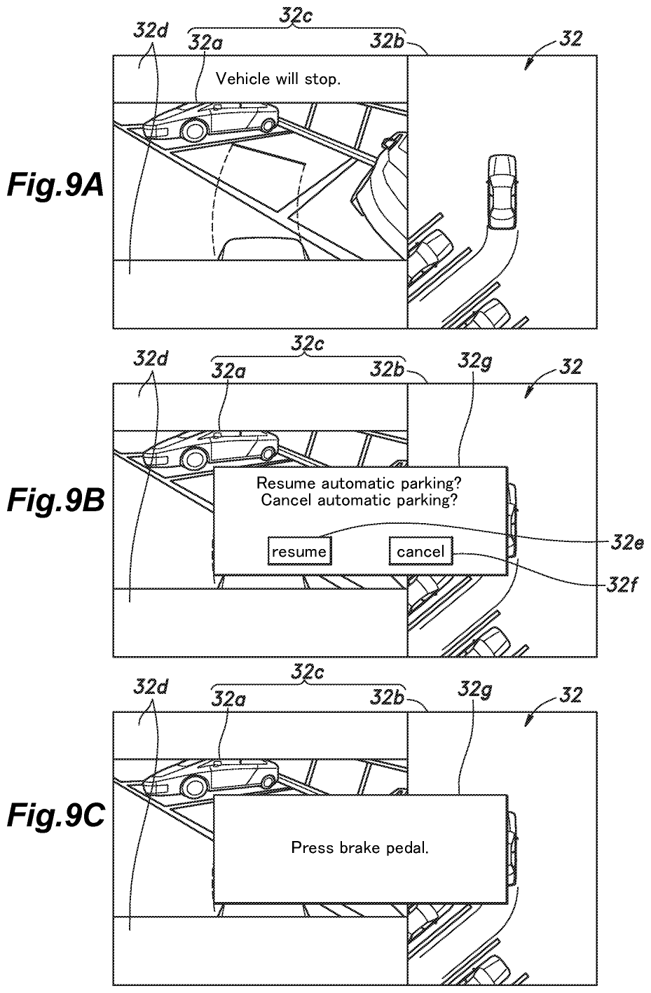

As shown in FIG. 9A, until the vehicle is stopped after starting to be decelerated in step ST17, the bird's-eye image 32a in the travel direction (the bird's-eye image 32a in the rear of the vehicle in FIG. 9A) is displayed on the left half of the touch panel 32 and the look-down image 32b is displayed on the right half of the touch panel 32. In the following, the bird's-eye image 32a and the look-down image 32b will be collectively described as “surrounding information display area 32c”. That is, the surrounding information display area 32c corresponds to an area in which the surrounding information of the vehicle acquired by the external cameras 19 (the surrounding information acquisition device) is displayed.

On the display screen of the touch panel 32, two notification windows 32d for displaying notifications to the occupant are provided outside the surrounding information display area 32c. In the present embodiment, the notification windows 32d are provided on upper and lower sides of the bird's-eye image 32a and on a left side of the look-down image 32b. That is, the notification windows 32d are set in areas that do not overlap with the surrounding information display area 32c.

In the present embodiment, until the vehicle is stopped after starting to be decelerated in step ST17, the action plan unit 43 makes the notification window 32d (for example, the notification window 32d provided on the upper side of the bird's-eye image 32a) display a stop notification that the vehicle will be stopped (see FIG. 9A). In this way, by making the notification window 32d display the stop notification while the vehicle is decelerating, it is possible to display the stop notification outside the surrounding information display area 32c including the bird's-eye image 32a and the look-down image 32b. Accordingly, the stop notification does not prevent the surrounding information display area 32c from displaying the bird's-eye image 32a and the look-down image 32b, so that it is possible to prevent one of the bird's-eye image 32a and the look-down image 32b from becoming indistinct for the occupant.

When it is determined that the state of the vehicle is the prohibition state (Yes in step ST16), the vehicle is decelerated and stopped (step ST17). Thereafter, in a case where the pressing amount of the brake pedal 24 becomes equal to or more than the pressing threshold, namely, in a case where the pressing of the brake pedal 24 becomes sufficient (Yes in step ST19), the action plan unit 43 makes the touch panel 32 display the pop-up window 32g including the resumption button 32e and the cancellation button 32f as shown in FIG. 9B (step ST20). The resumption button 32e is a button for receiving an input for resuming the autonomous parking operation, and the cancellation button 32f is a button for receiving an input for canceling the autonomous parking operation. When the occupant pushes the resumption button 32e, the action plan unit 43 executes the confirmation process of step ST30. When the occupant pushes the cancellation button 32f, the automatic parking process (the driving process) ends and the autonomous parking operation is canceled.

When it is determined that the state of the vehicle is the prohibition state (Yes in step ST16), the vehicle is decelerated and stopped (step ST17). Thereafter, in a case where the pressing amount of the brake pedal 24 is less than the pressing threshold, namely, in a case where the input to the brake pedal 24 is insufficient (No in step ST19), as shown in FIG. 9C, the action plan unit 43 makes the touch panel 32 display the pop-up window 32g including the pressing notification in the surrounding information display area 32c such that the pressing notification overlaps with the bird's-eye image 32a and the look-down image 32b. Thereby, the pressing notification can be displayed large on the touch panel 32, so that the occupant can easily understand that the pressing of the brake pedal 24 is necessary.

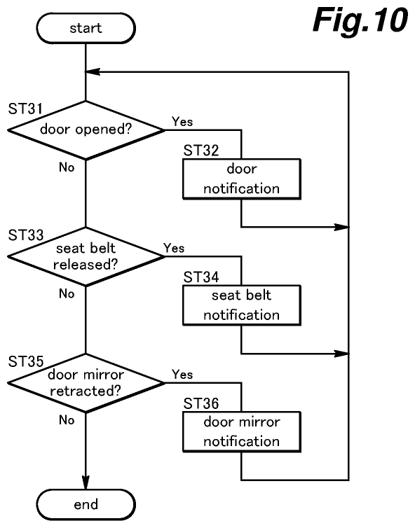

The confirmation process is a process for confirming that the state of the vehicle is not the prohibition state and notifying the occupant of the cause of the prohibition state when the state of the vehicle is the prohibition state so as to urge the occupant to eliminate the cause of the prohibition state. Hereinafter, the details of the confirmation process will be described with reference to FIG. 10.

In the following, a simple example of the confirmation process will be described. In this example, the vehicle state determining unit 46 determines that the state of the vehicle is the prohibition state in a case where one or more of three prohibition conditions (hereinafter referred to as “first to third conditions”) are satisfied. That is, in a case where one or more of the three prohibition conditions is satisfied during the automatic parking process (the driving process), the vehicle state determining unit 46 determines that the state of the vehicle is the prohibition state (step ST16), and the action plan unit 43 decelerates and stops the vehicle (step ST17). The first condition is a condition that “the door corresponding to a driver's seat is opened”, the second condition is a condition that “the seat belt of the driver's seat is released”, and the third condition is a condition that “the door mirrors are retracted”. The necessity for prohibiting the autonomous parking operation and dealing with the prohibition conditions becomes greater in the order of the third condition, the second condition, and the first condition. However, the first to third conditions are merely examples, and other conditions may be included in the prohibition conditions.

In the first step ST31 of the confirmation process, the action plan unit 43 determines whether the first condition is satisfied, namely, whether the door corresponding to the driver's seat is opened. In a case where the action plan unit 43 determines that the door corresponding to the driver's seat is opened, the action plan unit 43 executes step ST32. In a case where the action plan unit 43 determines that the door corresponding to the driver's seat is closed, the action plan unit 43 executes step ST33.

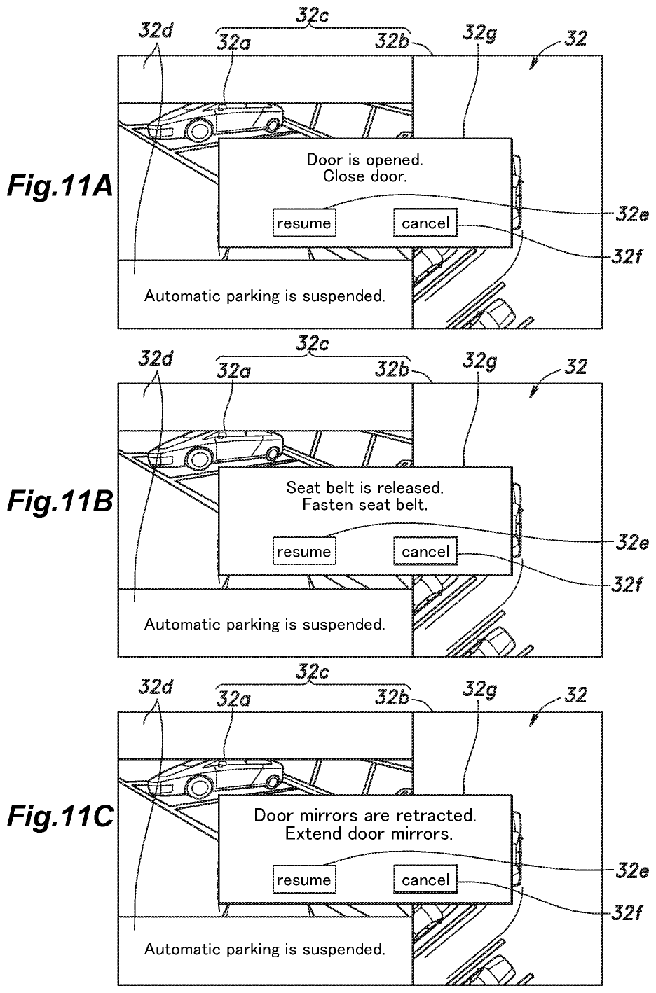

In step ST32, as shown in FIG. 11A, the action plan unit 43 makes the touch panel 32 display the pop-up window 32g in the surrounding information display area 32c. The pop-up window 32g of step ST32 includes a door notification (a text notification) to urge the occupant to close the door, the resumption button 32e, and the cancellation button 32f. At this time, the action plan unit 43 makes the touch panel 32 display the resumption button 32e in an inactive state where the resumption button 32e cannot receive the input by the occupant, and makes the touch panel 32 display the cancellation button 32f in an active state where the cancellation button 32f can receive the input by the occupant. In a case where the action plan unit 43 executes step ST32 repeatedly, the action plan unit 43 may maintain the pop-up window 32g displayed in previous step ST32 without displaying a new pop-up window 32g. After the pop-up window 32g is displayed, the action plan unit 43 executes step ST31 while maintaining the pop-up window 32g. In this way, while the first condition is satisfied (namely, while the door corresponding to the driver's seat is opened), the action plan unit 43 executes step ST31 repeatedly, and waits until the door corresponding to the driver's seat is closed. In step ST32, in a case where the input to the cancellation button 32f is detected, the action plan unit 43 ends both the confirmation process and the automatic parking process (the driving process).

In step ST33, the action plan unit 43 determines whether the second condition is satisfied, namely, whether the seat belt of the driver's seat is released. In a case where the action plan unit 43 determines that the seat belt of the driver's seat is released, the action plan unit 43 executes step ST34. In a case where the action plan unit 43 determines that the seat belt of the driver's seat is fastened, the action plan unit 43 executes step ST35.

In step ST34, as shown in FIG. 11B, the action plan unit 43 makes the touch panel 32 display the pop-up window 32g in the surrounding information display area 32c. The pop-up window 32g of step ST34 includes a seat belt notification (a text notification) to urge the occupant to fasten the seat belt, the resumption button 32e, and the cancellation button 32f. At this time, the action plan unit 43 makes the touch panel 32 display the resumption button 32e in an inactive state where the resumption button 32e cannot receive the input by the occupant, and makes the touch panel 32 display the cancellation button 32f in an active state where the cancellation button 32f can receive the input by the occupant. In a case where the action plan unit 43 executes step ST34 repeatedly, the action plan unit 43 may maintain the pop-up window 32g displayed in previous step ST34 without displaying a new pop-up window 32g. After the pop-up window 32g is displayed, the action plan unit 43 executes step ST31 while maintaining the pop-up window 32g. In step ST34, in a case where the input to the cancellation button 32f is detected, the action plan unit 43 ends both the confirmation process and the automatic parking process (the driving process).

In step ST35, the action plan unit 43 determines whether the third condition is satisfied, namely, whether the door mirrors are retracted. In a case where the action plan unit 43 determines that the door mirrors are retracted, the action plan unit 43 executes step ST36. In a case where the action plan unit 43 determines that the door mirrors are not retracted (namely, the door mirrors are extended), the action plan unit 43 ends the confirmation process and execute step ST11.

In step ST36, as shown in FIG. 11C, the action plan unit 43 makes the touch panel 32 display the pop-up window 32g in the surrounding information display area 32c. The pop-up window 32g of step ST36 includes a door mirror notification (a text notification) to urge the occupant to extend the door mirrors, the resumption button 32e, and the cancellation button 32f. At this time, the action plan unit 43 makes the touch panel 32 display the resumption button 32e in an inactive state where the resumption button 32e cannot receive the input by the occupant, and makes the touch panel 32 display the cancellation button 32f in an active state where the cancellation button 32f can receive the input by the occupant. In a case where the action plan unit 43 executes step ST36 repeatedly, the action plan unit 43 may maintain the pop-up window 32g displayed in previous step ST36 without displaying a new pop-up window 32g. After the pop-up window 32g is displayed, the action plan unit 43 executes step ST31 while maintaining the pop-up window 32g. In step ST36, in a case where the input to the cancellation button 32f is detected, the action plan unit 43 ends both the confirmation process and the automatic parking process (the driving process).

Next, the effect of the parking assist system 51 configured as described above will be described. The pop-up window 32g including the resumption button 32e and the cancellation button 32f is displayed on the touch panel 32 in a case where the brake pedal 24 is sufficiently pressed (Yes in step ST19). In this way, after the vehicle is stopped, the resumption button 32e is displayed on condition that the brake pedal 24 is pressed. After the resumption button 32e is pushed, the autonomous parking operation is resumed and the vehicle is moved (step ST23). In this way, since the pressing of the brake pedal 24 is set to a condition for resuming the autonomous parking operation, the autonomous parking operation is resumed after confirming that the occupant is in a posture to press the brake pedal 24, so that the safety of the vehicle is enhanced.

Even if the first to third conditions are satisfied, the pop-up window 32g including the resumption button 32e and the cancellation button 32f is displayed on the touch panel 32 in step ST20. That is, even if the state of the vehicle is the prohibition state, the resumption button 32e is displayed (namely, the input to the resumption button 32e is not prohibited) on condition that the brake pedal 24 is pressed. In this way, even if the state of the vehicle is the prohibition state, the input for resuming the autonomous parking operation is received, so that the occupant can perform the input for resuming the autonomous parking operation without noticing that the state of the vehicle is the prohibition state. Thereby, the occupant can perform the input for resuming the autonomous parking operation without worrying about the state of the vehicle, so that the convenience of the vehicle is enhanced.

When the occupant pushes the resumption button 32e in step ST20, the confirmation process is performed. When one or more of the prohibition conditions are satisfied in the confirmation process, the action plan unit 43 makes the touch panel 32 sequentially display notifications respectively related to the prohibition conditions being satisfied. In this way, the notifications related to the prohibition conditions are not displayed on the touch panel 32 at once but sequentially displayed on the touch panel 32, so that the occupant can reliably recognize the notifications related to the prohibition conditions. Further, since the notifications related to the prohibition conditions are displayed in the surrounding information display area 32c, the occupant can easily understand the notifications related to the prohibition conditions.

When the occupant pushes the cancellation button 32f in step ST20, the autonomous parking operation (the automatic parking process) ends. Accordingly, in a case where the occupant does not desire to resume the autonomous parking operation, the touch panel 32 does not display a notification related to the state of the vehicle. Accordingly, it is possible to prevent an unnecessary notification from being displayed on the touch panel 32 in a case where the occupant does not desire to resume the autonomous parking operation.

### Third Embodiment

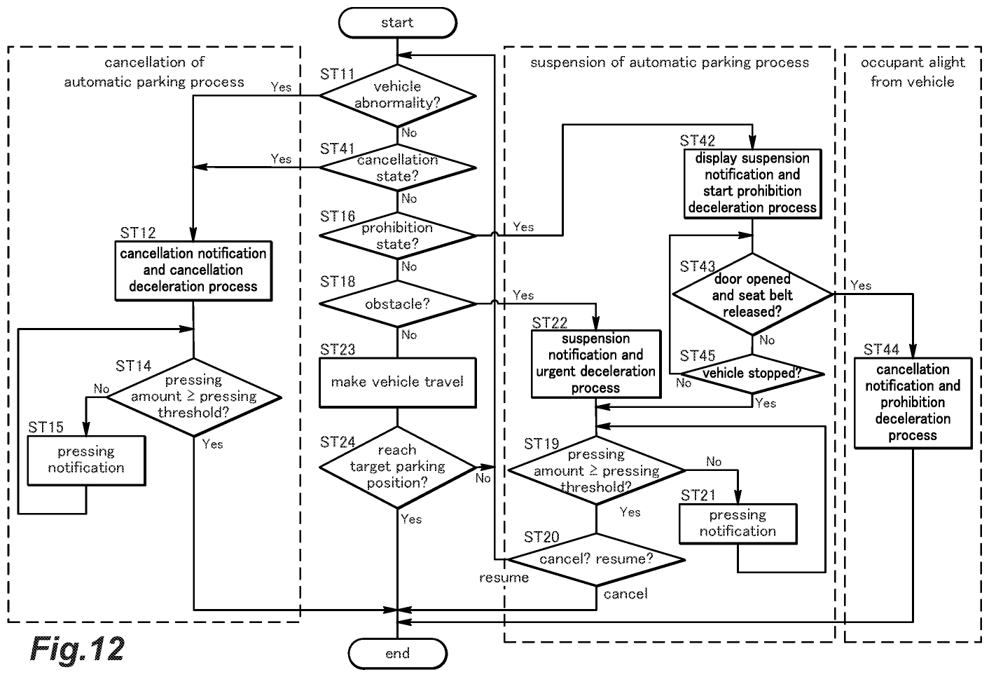

The parking assist system 101 according to the third embodiment is different from the parking assist system 1 according to the first embodiment in the driving process and is similar to the parking assist system 1 according to the first embodiment in other processes. Further, as shown in FIG. 12, the driving process according to the third embodiment is different from the driving process according to the first embodiment in that step ST41 is provided instead of step ST13 and that steps ST42 to ST45 are provided instead of step ST17.

Further, in the present embodiment, the vehicle is provided with two seats (a driver's seat and a passenger seat), two door open/close sensors 29, and two seat belt sensors 30. One door open/close sensor 29 is attached to a door provided on a side of the driver's seat, and the other door open/close sensor 29 is attached to a door provided on a side of the passenger seat. Each door open/close sensor 29 detects opening/closing of the door to which each door open/close sensor 29 is attached. Further, one seat belt sensor 30 is provided at a seat belt of the driver's seat, and the other seat belt sensor 30 is provided at a seat belt of the passenger seat. Each seat belt sensor 30 is configured to detect a fastening state of the seat belt of each seat. In a case where each door open/close sensor 29 (for example, at least one door open/close sensor 29) detects that the door is opened or each seat belt sensor 30 (for example, at least one seat belt sensor 30) detects that the seat belt is released, the vehicle state determining unit 46 determines that the state of the vehicle is the prohibition state.

In the following, with reference to FIG. 12, the driving process according to the third embodiment will be described. In step ST41, the vehicle state determining unit 46 determines whether the state of the vehicle is the cancellation state, as in step ST13 of the first embodiment. Incidentally, the vehicle state determining unit 46 does not determine that the state of the vehicle is the cancellation state in a case where the door is opened and the seat belt is released, and determines that the state of the vehicle is the cancellation state in a case where the cancellation button is pushed.

The action plan unit 43 executes step ST42 in a case where it is determined that the state of the vehicle is the prohibition state in step ST16. In step ST42, the action plan unit 43 makes the touch panel 32 display the pop-up window including the suspension notification that the automatic parking process (autonomous parking operation) is suspended, as in step ST17 of the first embodiment. Thereafter, the action plan unit 43 starts the prohibition deceleration process to decelerate the vehicle so as to stop the vehicle. Thereafter, the action plan unit 43 executes step ST43.

In step ST43, the action plan unit 43 determines whether each door open/close sensor 29 (for example, at least one door open/close sensor 29) detects that the door corresponding to the driver's seat or the door corresponding to the passenger seat (namely, the door corresponding to the seat other than the driver's seat) is opened. In addition, the action plan unit 43 determines whether each seat belt sensor 30 (for example, at least one seat belt sensor 30) detects that the seat belt corresponding to the opened door (More specifically, the seat belt of the seat located near the door which is detected to be opened) is released. In a case where each door open/close sensor 29 (for example, at least one door open/close sensor 29) detects that the door is opened and each seat belt sensor 30 (for example, at least one seat belt sensor 30) detects that the seat belt corresponding to the opened door is released (Yes in step ST43), the action plan unit 43 executes step ST44. Otherwise (No in step ST43), the action plan unit 43 executes step ST45.

In step ST44, the action plan unit 43 continues the prohibition deceleration process in order to stop the vehicle, and makes the touch panel 32 display the pop-up window including the cancellation notification that the automatic parking process is canceled. When the vehicle is stopped, the action plan unit 43 completes step ST44 and ends the automatic parking process (driving process). After the vehicle is stopped, the action plan unit 43 may make the touch panel 32 keep on displaying the cancellation notification until the touch panel 32 receives a prescribed input.

In step ST45, the action plan unit 43 determines whether the vehicle has been stopped. The action plan unit 43 may determine whether the vehicle has been stopped based on whether the vehicle speed has become sufficiently low. When the action plan unit 43 determines that the vehicle has been stopped, the action plan unit 43 ends step ST45 and executes step ST19.

Next, the effect of the parking assist system 101 configured as described above will be described. When the condition that the seat belt is released and the condition that the door corresponding to the released seat belt (namely, the door near the seat at which the seat belt is released) is opened are both satisfied (Yes in step ST43), step ST44 is executed. As a result, the vehicle is stopped and the driving process ends, and thereafter, the parking process of step ST5 is executed and the shift position is changed to the parking position.

In a case where the condition that each door open/close sensor 29 detects that the door is opened and the condition that the seat belt corresponding to the opened door (that is, the seat belt of the seat located near the opened door) is released (hereinafter, these two conditions will be referred to as “alighting conditions”) are satisfied, the occupant seated on the seat is likely to alight from the vehicle. In the present embodiment, as shown in FIG. 12, even if the pressing (input) to the brake pedal 24 is detected in a case where the two alighting conditions are satisfied and the user is likely to alight from the vehicle, the autonomous parking operation is not allowed to resume. Therefore, when the occupant surely intends to alight from the vehicle, it is possible to prevent the vehicle from moving, so that the safety of the vehicle is enhanced.

Further, when the two alighting conditions are satisfied, the vehicle is stopped. Thereafter, the shift position is changed to the parking position and the vehicle is fixed. Therefore, it is possible to prevent the vehicle from being fixed only by the brake device 5 after the user alights from the vehicle, so that the safety of the vehicle is enhanced.

In the present embodiment, when the occupant seated on either the driver's seat or the seat other than the driver's seat (namely, passenger seat) releases the seat belt and opens the door, the vehicle is stopped and the shift position is changed to the parking position. Accordingly, when not only the driver but all the occupants are about to alight from the vehicle, the vehicle can be stopped and fixed at the position where the vehicle is stopped, so that the safety of the vehicle can be improved.

Concrete embodiments of the present invention have been described in the foregoing, but the present invention should not be limited by the foregoing embodiments and various modifications and alterations are possible within the scope of the present invention. In the above embodiment, the automatic parking process is executed by the parking assist system 1, but the present invention is not limited to this embodiment. More specifically, the parking assist system 1 may allow the resumption of the automatic unparking process (driving process) on condition that the brake pedal 24 is pressed when the automatic unparking process is suspended. Further, in the above embodiment, the parking assist system 1 is capable of executing the automatic parking process and the automatic unparking process, but the present invention is not limited to this embodiment. The parking assist system 1 may be capable of executing the automatic parking process or the automatic unparking process.

In the above embodiment, the pressing notification to urge the driver to press the brake pedal 24 is displayed in the pop-up window to notify the cancellation or suspension of the driving operation, but the present invention is not limited to this embodiment. The pressing notification to urge the driver to press the brake pedal 24 may be displayed on the touch panel 32 as another pop-up window that is different from the pop-up window to notify the cancellation or suspension of the driving operation.

In the above third embodiment, the door open/close sensors 29 are provided at each door corresponding to the driver's seat and the passenger seat, and the seat belt sensors 30 are provided at each seat belt corresponding to the driver's seat and the passenger seat. However, the present invention is not limited to this embodiment. The seat belt sensor 30 may be provided only at the seat belt corresponding to the driver's seat, and the door open/close sensor 29 may be provided only at the door corresponding to the driver's seat. According to this arrangement, when the driver who checks the travel of the vehicle tries to alight from the vehicle, the vehicle can be stopped and fixed, so that the safety of the vehicle can be improved.

In the third embodiment, the vehicle is provided with only the driver's seat and the passenger seat, but the present invention is not limited to this embodiment. The vehicle may be provided with plural rows of seats aligned in the fore and aft direction. In such a case, the door open/close sensors 29 may be provided at the door corresponding to the driver's seat and the door corresponding to the seat of the other occupants, and the seat belt sensors 30 may be provided at the seat belt of each seat. When each seat belt sensor 30 (for example, at least one seat belt sensor 30) detects that the seat belt is released and each door open/close sensor 29 (for example, at least one door open/close sensor 29) detects that a specific door (namely, the door supposed to be opened when the occupant seated on the seat at which the seat belt is released alights from the vehicle) is opened, the action plan unit 43 may determine that the two alighting conditions are satisfied, and stop the vehicle. Thereafter, the action plan unit 43 may make the shift actuator 17 change the shift position to the parking position.

In the above embodiment, the vehicle state determining unit 46 determines that the state of the vehicle is the cancellation state when the cancellation button 32f is pushed, but the present invention is not limited to this embodiment. For example, the vehicle state determining unit 46 may determine that the state of the vehicle is the cancellation state when the parking main switch 34 is operated.

1. A parking assist system, comprising:
a control device configured to control an autonomous parking operation to move a vehicle autonomously to a prescribed target parking position;
a brake input member configured to receive an input of a brake operation of the vehicle by an occupant, and
a vehicle state detecting device configured to detect a state of the vehicle,
wherein during control of the parking operation, when the control device determines that the state of the vehicle detected by the vehicle state detecting device is a prohibition state in which the parking operation should be prohibited, the control device stops a movement of the vehicle and does not allow the parking operation to resume unless the input to the brake input member is detected.

2. The parking assist system according to claim 1, wherein the control device resumes the movement of the vehicle when the input to the brake input member is released after the input to the brake input member is detected.

3. The parking assist system according to claim 2, further comprising an input/output device configured to receive an input by the occupant and to execute a prescribed notification to the occupant based on an instruction from the control device,
wherein when the control device determines that the state of the vehicle is the prohibition state, the control device stops the movement of the vehicle, makes the input/output device execute a notification to urge the input to the brake input member, and makes the input/output device receive an input as to whether to resume the parking operation, and
when the input to the brake input member is detected and the input/output device receives an input for resuming the parking operation, the control device resumes the parking operation.

4. The parking assist system according to claim 3, wherein when an abnormality of the vehicle including the input/output device is detected, the control device stops the movement of the vehicle and makes the input/output device execute a notification to urge the input to the brake input member.

5. The parking assist system according to claim 4, further comprising a shift actuator configured to change a shift position based on a signal from the control device,
wherein when the abnormality of the vehicle including the input/output device is detected, the control device stops the movement of the vehicle, and
when the input to the brake input member is detected, the control device drives the shift actuator so as to change the shift position to a parking position.

6. The parking assist system according to claim 1, wherein the vehicle state detecting device includes a driving operation sensor configured to detect an input of a driving operation by the occupant, and
the control device determines that the state of the vehicle is the prohibition state in a case where the driving operation sensor detects the input of the driving operation.

7. The parking assist system according to claim 1, wherein the vehicle state detecting device includes at least one of a door open/close sensor configured to detect opening and/or closing of a door of the vehicle, a seat belt sensor configured to detect a fastening state of a seat belt, and a door mirror position sensor configured to detect a position of a door mirror, and
the control device is configured to determine whether the state of the vehicle is the prohibition state based on a detection result of the at least one of the door open/close sensor, the seat belt sensor, and the door mirror position sensor.

8. The parking assist system according to claim 1, further comprising:
a surrounding information acquisition device configured to acquire surrounding information of the vehicle; and
an input/output device configured to receive an input by the occupant, to execute a prescribed notification to the occupant, and to display the surrounding information acquired by the surrounding information acquisition device,
wherein when the control device determines that the state of the vehicle is the prohibition state, the control device makes the input/output device display the surrounding information in a prescribed display area and display a prescribed notification to the occupant outside the display area until the vehicle is stopped.

9. The parking assist system according to claim 8, wherein when the control device determines that the state of the vehicle is the prohibition state, the control device decelerates the vehicle so as to stop the vehicle, and
after the vehicle is stopped, when the input to the brake input member is detected, the control device makes the input/output device receive an input for resuming the parking operation.

10. The parking assist system according to claim 9, wherein when the control device determines that the state of the vehicle is the prohibition state, the control device decelerates the vehicle so as to stop the vehicle, and
after the vehicle is stopped, when the input to the brake input member is detected, the control device makes the input/output device receive the input for resuming the parking operation regardless of whether the state of the vehicle is the prohibition state.

11. The parking assist system according to claim 9, wherein when one or more prohibition conditions are satisfied, the control device determines that the state of the vehicle is the prohibition state and stops the vehicle,
after the vehicle is stopped, when the input to the brake input member is detected and the input/output device receives an input for resuming the parking operation in a state where the prohibition conditions are satisfied, the control device makes the display area of the input/output device sequentially display notifications respectively related to the prohibition conditions being satisfied, and
the control device allows the parking operation to resume when all the prohibition conditions become unsatisfied.

12. The parking assist system according to claim 8, wherein when the control device determines that the state of the vehicle is the prohibition state, the control device decelerates the vehicle so as to stop the vehicle, and
after the vehicle is stopped, the control device makes the input/output device display a notification to urge the input to the brake input member in the display area.

13. The parking assist system according to claim 1, wherein the vehicle state detecting device includes at least one door open/close sensor configured to detect opening and/or closing of at least one door of the vehicle and at least one seat belt sensor configured to detect a fastening state of at least one seat belt corresponding to the door,
when the door open/close sensor detects that the door of the vehicle is opened or the seat belt sensor detects that the seat belt is released, the control device determines that the state of the vehicle is the prohibition state, and
in a case where the door open/close sensor detects that the door of the vehicle is opened and the seat belt sensor detects that the seat belt is released when the state of the vehicle is the prohibition state, the control device does not allow the parking operation to resume even if the input to the brake input member is detected.

14. The parking assist system according to claim 13, further comprising a shift actuator configured to change a shift position based on a signal from the control device,
wherein in a case where the door open/close sensor detects that the door of the vehicle is opened and the seat belt sensor detects that the seat belt is released when the state of the vehicle is the prohibition state, the control device makes the shift actuator change the shift position to a parking position after stopping the movement of the vehicle.

15. The parking assist system according to claim 13, wherein the at least one door comprises a door corresponding to a driver's seat.

16. The parking assist system according to claim 13, wherein the at least one door comprises a door corresponding to a driver's seat and a door corresponding to a seat other than the driver's seat.
